(19) United States
(12) Patent Application Publication
(10) Pub. No.: US 2007/0041167 A1
(43) Pub. Date: Feb. 22, 2007

(54) Medical lighting apparatus

(75) Inventor: Akio Nachi, Tokyo (JP)

Correspondence Address: BIRCH STEWART KOLASCH & BIRCH, PO BOX 747, FALLS CHURCH, VA, 22040-0747, US

(73) Assignee: Dai-Ichi Shomei Co., Ltd.

(21) Appl. No.: 11/451,364

(22) Filed: Jun. 13, 2006

(30) Foreign Application Priority Data
Aug. 19, 2005 (JP) 2005-239172

(51) Int. Cl. A61G 13/00

(52) U.S. Cl. 362/33; 362/294; 362/241

(57) ABSTRACT

A medical lighting apparatus includes single or plural LED units. Each of the LED units comprises a plurality of concave reflecting surfaces and an LED element disposed in front of each of the reflecting surface so as to radiate light toward each of the reflecting surfaces. Each of the LED units is arranged so that the lights radiated from its LED elements are reflected by the reflecting surfaces, emerge outside and are superimposed on one another on an area to be illuminated, respectively, while illuminating the area. The LED elements of each of the LED units comprise a combination of different emitting colors so as to enhance the color rendering properties.

### BACKGROUND OF THE INVENTION

1. Field of the Invention

This invention relates to a medical lighting apparatus for illuminating an area such as an operative area of a patient in the medical field.

2. Related Art

This kind of conventional medical lighting apparatus employs incandescent bulbs such as halogen lamps as the light sources (see, for example, Japanese Laid-Open Patent Publication No. 4-312457).

The conventional medical lighting apparatus using incandescent bulbs presents the following problems, since the light sources generate a significant amount of heat. There is danger of the heat drying out an affected area of a patient or causing a low-temperature burn. The heat also causes discomfort to an operator with being radiated to his or her head, neck or shoulder.

On the other hand, recently high-intensity LEDs (Light Emitting Diodes) have been developed and they generate much less heat than incandescent bulbs. Therefore, it can be expected that the prior art problems will be overcome by use of high-intensity LEDs instead of incandescent bulbs.

However, LEDs now available present a problem that their color rendering properties are unsatisfactory for use in medical lighting apparatus.

Also, there are problems that, if lights from LEDs are condensed with lenses, it is prone to produce a nonuniform light distribution, resulting in shadows on the area to be illuminated, and of the lights emitted from light emitting parts of LEDs, those go toward the periphery far from the axis of the LEDs cannot be put to effective use, resulting in low light efficiency.

Furthermore, though LEDs produce much less heat than incandescent lamps and their heat generation does not cause harmful effects to the patient or the operator, still there is a problem that, unless adequate heat dissipation is provided, the LED itself's life is shortened considerably.

### SUMMARY OF THE INVENTION

It is accordingly an object of the present invention to provide a medical lighting apparatus that uses LEDs as the light sources, and still has good color rendering properties.

It is another object of the present invention to provide a medical lighting apparatus that uses LEDs as the light source, and still can minimize the formation of shadows.

It is still another object of the present invention to provide a medical lighting apparatus that can make highly effective use of LEDs' light output.

It is a further object of the present invention to provide a medical lighting apparatus that can provide good heat dissipation from LEDs to extend the LEDs' life.

The other objects of the present invention will become apparent from the following detailed description.

A medical lighting apparatus in accordance with the present invention includes single or plural LED units. Each of the LED units comprises a plurality of concave reflecting surfaces and an LED element disposed in front of each of the reflecting surfaces so as to radiate light toward each of the reflecting surfaces. Each of the LED units is arranged so that the lights radiated from its LED elements are reflected by the reflecting surfaces, emerge outside and are superimposed on each other on an area to be illuminated, respectively, while illuminating the area. The LED elements of each of the LED units comprise a combination of different emitting colors so as to enhance the color rendering properties.

The medical lighting apparatus of the present invention uses a combination of LED elements of different emitting colors in every LED unit instead of using LED elements of the same single emitting color. Therefore, the color rendering properties can be improved as a whole.

In the medical lighting apparatus of the present invention, since the lights radiated from the LED elements are converged by the concave reflecting surfaces, uniform light distribution can be achieved, minimizing the formation of shadows, and even the lights from the light emitting parts of the LED elements which go toward the periphery far from the axis of the LED elements can be put to effective use, achieving highly effective use of LED elements' light output.

In a particular aspect of the medical lighting apparatus of the present invention, there are provided an LED supporting member supporting the LED element and heatsink plates extending radially from the LED supporting member. The heatsink plates are arranged to extend widthwise in the plane substantially parallel to the optical axis of the concave reflecting surface. Accordingly, when viewed in parallel to the optical axis of the reflecting surface, the plate thickness of the heatsink plates can be seen. Such construction enables adequate heat dissipation from LEDs to extend the LEDs' life, and still substantially prevents the presence of the heatsink plates from obstructing the light illumination.

### BRIEF DESCRIPTION OF THE DRAWINGS

The foregoing and the other objects, features and advantages of the present invention will become apparent from the following detailed description when taken in connection with the accompanying drawings. It is to be understood that the drawings are designated for the purpose of illustration only and are not intended as defining the limits of the invention.

FIG. 1 is a side elevational view of a medical lighting apparatus in accordance with the present invention as shown being mounted on the ceiling of an operating theater, etc. through an arm.

FIG. 2 is a cross sectional view of the embodiment.

FIG. 3 is a bottom view of the embodiment as shown with its lamp covers omitted.

FIG. 4 is a plan view of connection between a rotating member and focus connectings rod in the embodiment.

FIG. 5 is a enlarged cross sectional view showing a part of one of LED units in the embodiment.

FIG. 6 is a bottom view of one of reflecting members and its vicinity in the embodiment.

FIG. 7 is a plan view showing mounting of a unit board on the reflecting member in the embodiment.

### DETAILED DESCRIPTION OF THE PREFERED EMBODIMENT

The present invention will hereunder be described in conjunction with a preferred embodiment of the invention which is shown in the drawings. In the drawings like reference numerals are used throughout the various views to designate like parts.

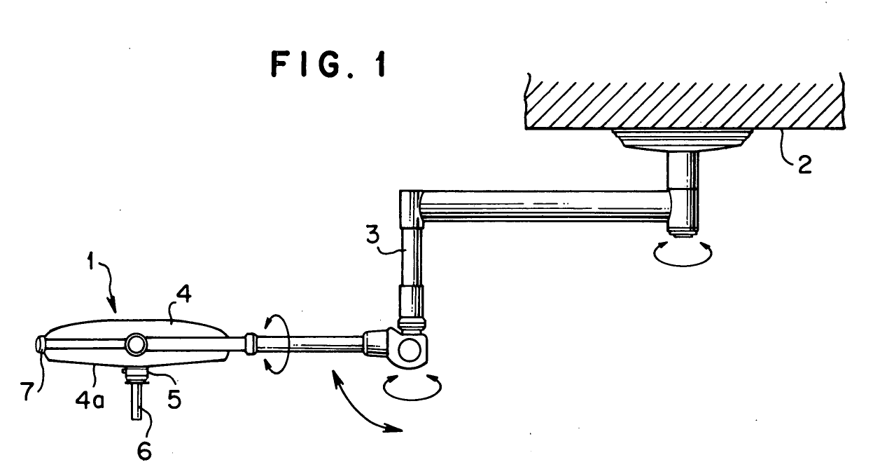

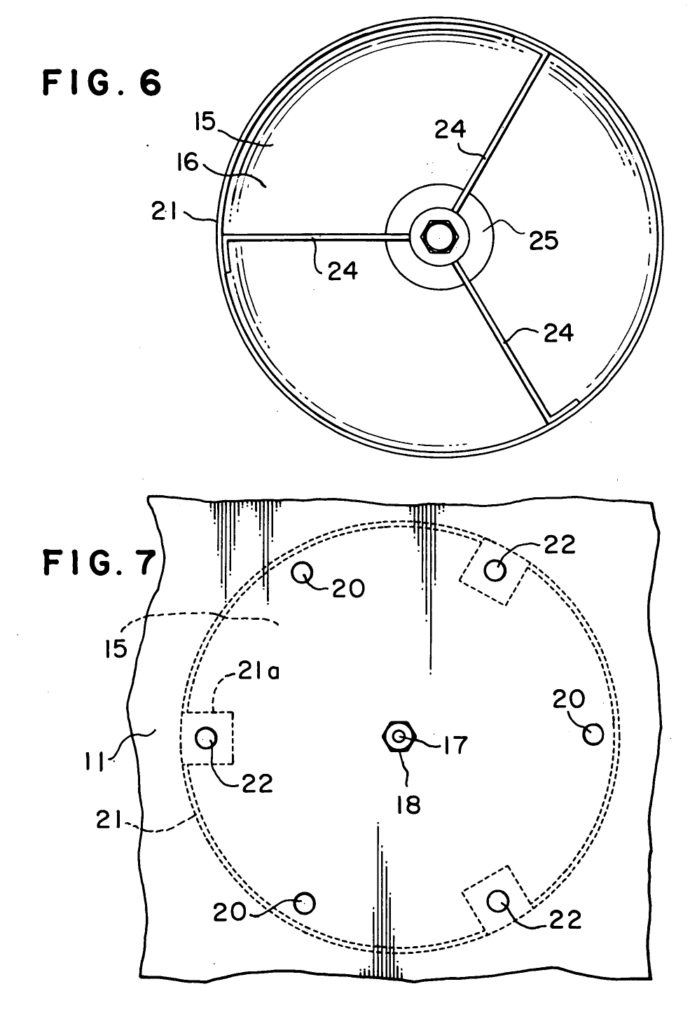

FIGS. 1 through 7 show an embodiment of the present invention. As shown in FIG. 1, a medical lighting apparatus 1 of the present embodiment is mounted on the ceiling 2, etc. of an operating theater, etc. through an arm 3 so that its position and posture are freely changeable.

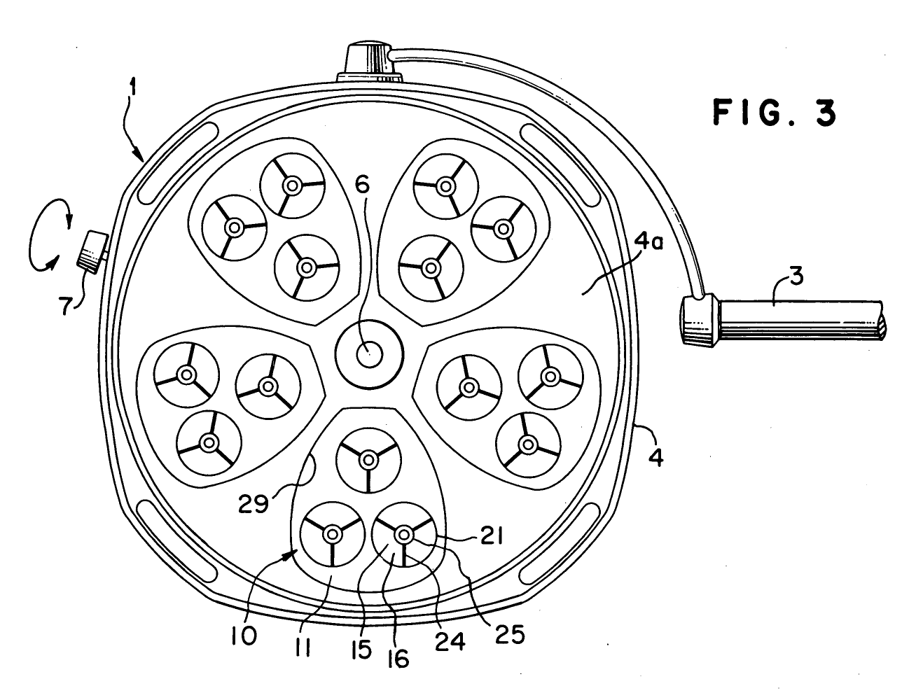

As shown FIG. 1 through 3, the medical lighting apparatus 1 has a generally saucer-shaped light main body 4, on the center of which lower part a coupler 5 is mounted protruding outside and downward. A center focus handle 6 is detachably mounted to the coupler 5. As shown in FIGS. 1 and 3, a focus control knob 7 is rotatably mounted on the outer periphery of the main body 4. The center focus handle 6 and the focus control knob 7 constitute focusing members in this embodiment, respectively.

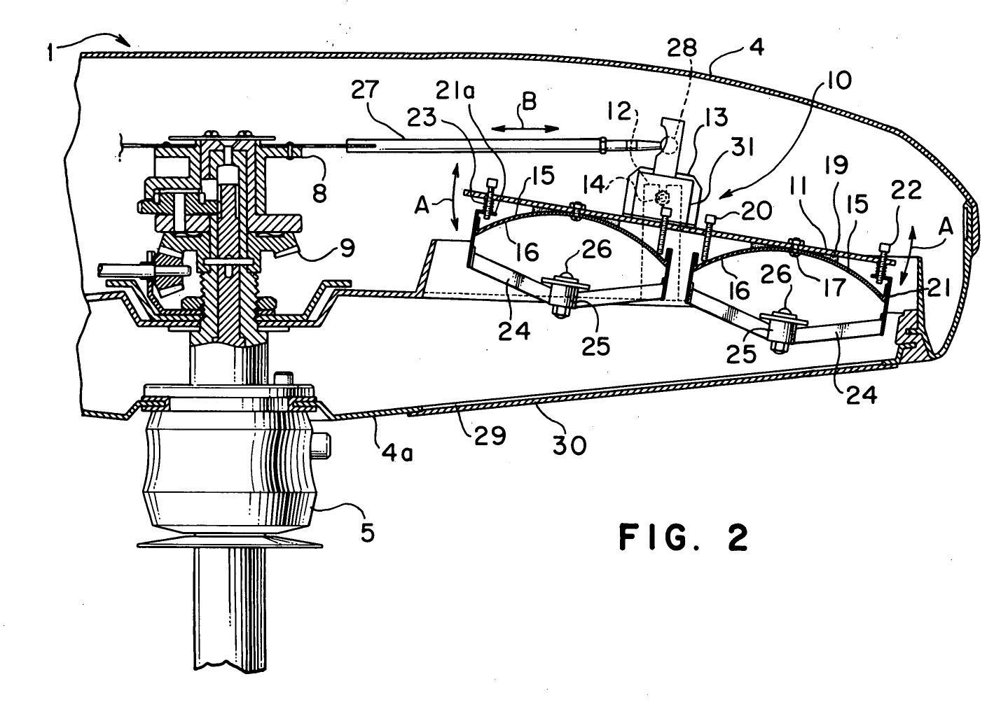

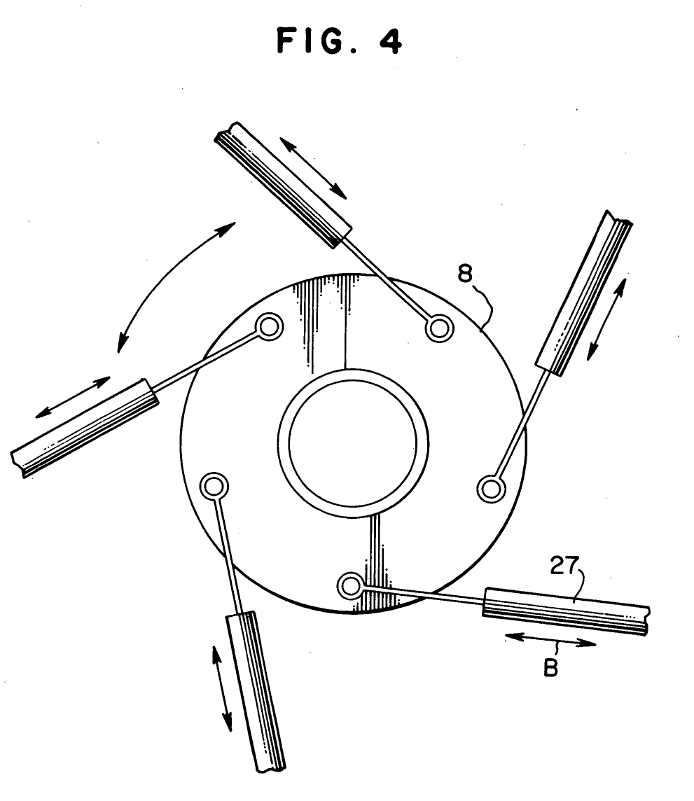

As shown in FIGS. 2 and 4, inside the main body 4 a rotating member 8 is rotatably supported about the axis of the main body 4. The center focus handle 6 and the focus control knob 7 are linked to the rotating member 8, respectively, through a power transmission mechanism 9 comprising wheels, etc. so that, when the center focus handle 6 or the focus control knob 7 is rotated, the rotating member 8 is rotated. Of the power transmission mechanism 9, the power transmission route from the center focus handle 6 to the rotating member 8 and the power transmission route from the focus control knob 7 to the rotating member 8 are partly common, that is, the two routes include common elements such as wheels.

As shown in FIGS. 2 and 3, inside the light main body 4, five LED units 10 are provided around the rotating member 8 at equal angular intervals. The details of the respective LED units 10 are as follows.

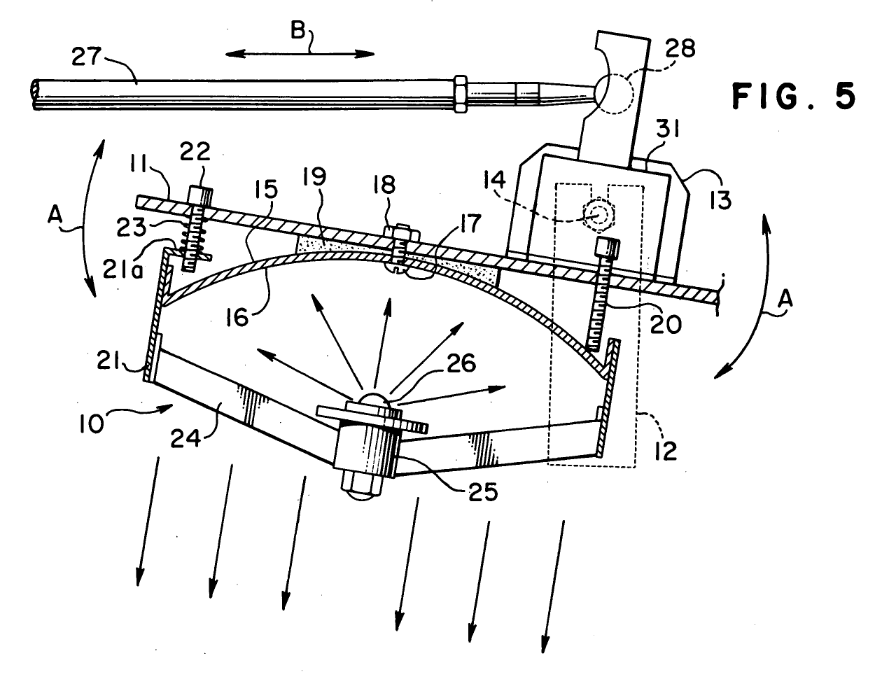

Each LED unit 10 has a flat-shaped unit board 11 formed of a punched metal plate with a number of small holes (not shown). Each unit board 11 is rotatably mounted to the main body 4, through a unit supporting member 12 (see FIGS. 2 and 5) fixed to the main body 4 and unit supporting member 13 fixed to the unit board 11, around a rotational axis 14 as shown by the arrow A so as to be tiltable relative to the central axis of main body 4. With this arrangement, each LED unit 10 as a whole is supported by the main body 4, tiltable relative to the central axis of main body 4 as indicated by the arrow A.

Three reflecting members 15 are supported by each of the unit boards 11. Each reflecting member 15 has a concave reflecting surface 16 having a paraboloidal surface or similar shaped surface, and is loosely mounted to the unit board 11 with a screw 17 and a nut 18 at the center of the concave reflecting surface 16. With this arrangement, each of the reflecting members 15 is tiltable to some extent in every direction relative to the unit boards 11. A foamed material member 19 having rubber elasticity such as urethane foam is interposed between the back of the center portion of the concave reflecting surface 16 of each reflecting member 15 and the unit board 11. As shown in FIGS. 2, 5 and 7, angle adjusting screws 20 are threadedly engaged with the unit board 11, arranged as a set of three at 120 degrees intervals for each reflecting member 15, and the forward ends thereof are adapted to be pressed against the backs of the reflecting members 15. Therefore, the inclination angle of each reflecting members 15 relative to the unit board 11 can be adjusted by rotation of the respective reflection angle adjusting screws 20.

Each of the reflecting members 15 is accommodated inside a reflecting member case 21 formed of metal having a generally short cylindrical-shape. Each of the reflecting member cases 21 is adapted to be movable relative to the unit board 11 and reflecting member 15 in a direction normal to the unit board 11 (generally the direction parallel to the optical axis of the reflecting member 15). As shown in FIGS. 2, 5 and 7, LED position adjusting screws 22 extending through the unit board 11 are threadedly engaged with three projecting bend portions 21a integrally formed on each reflecting member case 21 at 120 degrees intervals, respectively. Compression coil springs 23 are interposed between the unit boards 11 and the projecting bend portions 21a, with the screws 22 extending therethrough, and bias the reflecting member cases 21 away from the unit boards 11, respectively.

An LED supporting member 25 formed of metal such as cupper alloy or aluminum alloy is mounted on each of the reflecting member cases 21 through three strip-shaped heatsink plates 24 formed of metal such as cupper alloy or aluminum alloy. Each of the LED supporting members 25 is disposed in front of the concave reflecting surface 16 and on the optical axis of the concave reflecting surface 16. As shown in FIGS. 2, 3, 5 and 6, the heatsink plates 24 extend radially from the LED supporting members 25 to the reflecting member cases 21, while extending widthwise in the plane substantially parallel to the optical axes of the concave reflecting surfaces 16, respectively. Accordingly, when viewed in parallel to the optical axis of each of the reflecting surfaces 16, the plate thickness of each of the heatsink plates 24 can be seen. An LED element 26 is mounted on each of the LED supporting members 25 so as to be disposed on the optical axis and in front of each of the reflecting surfaces 16, and so as to radiate light toward each of the reflecting surfaces 16.

The total of three LED elements 26 provided on each of the LED units 10 are not of the same emitting color or emission spectrum, but comprise a combination of different emitting colors, white, blue and red so as to enhance the color rendering properties as a whole.

As shown in FIGS. 2 and 4, five focus connecting rods 27 are connected at the one ends thereof to the outer peripheral of the rotating member 8, relatively rotatably thereto, respectively. At the other ends the focus connecting rods 27 are connected to the respective LED unit boards 11 of LED units 10 through supporting members 31 and universal joint mechanisms 28, relatively rotatably thereto, respectively. The power transmission mechanism 9, the rotating member 8, the focus connecting rods 27 and the universal joint mechanisms 28, etc. constitute a focus adjusting linkage mechanism in this embodiment. Rotation of the rotating member 8 pushes or pulls the focus connecting rods 27 as indicated by the arrow B in FIGS. 2, 4 and 5, and thereby rotates the unit boards 11 and hence the LED units 10 about the rotational axes 14, respectively, as indicated by the arrow A in FIGS. 2 and 5 in synchronization with one another, whereby the angles of inclinations of the LED units 10 relative to the axis of the main body 4 are changed, respectively.

As shown in FIGS. 2 and 3, five openings 29 are provided on a lower cover 4a, which forms the lower part of the light main body 4, at positions corresponding to the LED units 10. The openings 29 are covered by transparent or translucent lamp covers 30, respectively (the lamp covers 30 are omitted from FIG. 3 in the interest of clarity).

Now, the operation of this embodiment will be described. The lights radiated from the LED elements 26 are reflected by the reflecting surfaces 16, converted to generally parallel rays of lights and emerge outside through the openings 29 and the lamp covers 30 (see FIGS. 2 and 3), respectively. The state of the light beams emerging from each of the reflecting surfaces 16 can be adjusted by turning the LED position adjusting screw 22 to adjust the distance between the reflecting member case 21 and the unit board 11 and hence that between the concave reflecting surface 16 and the LED element 26. Though, basically, the light emitting part of the Led element 26 is supposed to be on the focal point of the concave reflecting surface 16, adjustment of the distance between the concave reflecting surface 16 and the LED element 26 as stated above can adjust the size of light spot formed on the area to be illuminated.

The angle adjustments of the concave reflecting surfaces 16 in each of the LED unit 10 are achieved by turning the reflection angle adjusting screws 20 to change the distances the screws 20 travel pushing the backs of the reflecting members 15, respectively. By these angle adjustments, the light spots from three reflecting surfaces 16 in each of the LED units 10 are supposed to be superimposed at one point on the area to be illuminated which is supposed to be, for example, about one meter apart from the medical lighting apparatus 1.

In this embodiment, since a plurality of concave reflecting surfaces 16 in each of the LED units 10 are formed of separate members and thereby it is hard to accurately set the angle of each of the concave reflecting surfaces 16 from the beginning due to the manufacturing process, the concave reflecting surfaces 16 are constructed so that the inclination angles thereof can be adjusted, respectively, as stated above. However, for example, if a plurality of concave reflecting surfaces 16 in each LED unit 16 are integrally formed together, mechanisms for adjusting the angle inclination of reflecting surfaces 16 are not necessary.

Next, the adjustment of the light rays focus of the medical lighting apparatus 1 as a whole is achieved as follows. By rotating the center focus handle 6 or the focus control knob 7 to rotate the rotating member 8 through the power transmission mechanism 9 and thereby to pull or push the focus connecting rods 27, the LED units 10 are rotated simultaneously about the rotational axes 14 as shown by the arrow A in FIGS. 2 and 5 to change the inclination angles of the LED units 10 relative to the axis of the main body 4, respectively. This enables the adjustment of the focus of the light rays emerging from the entire medical lighting apparatus 1.

When thus adjusted, the lights radiated from LED elements 26 are reflected by the reflecting surfaces 16, emerge outside, respectively, and are superimposed on one another on an area to be illuminated, while at the same time illuminating the area. Since this medical lighting apparatus 1 uses a combination of LED elements of different colors in every LED unit 10 instead of using LED elements of the same single color, the color rendering properties as a whole can be highly enhanced.

Also, since the lights radiated from the LED elements 26 are converged by the concave reflecting surfaces 16, uniform light distribution can be achieved, minimizing the formation of shadows, and even the lights emerged from light emitting parts of LED elements 26 toward the periphery far from the axis of the LED elements 26 can be put to effective use, achieving highly effective use of LED elements' light output.

Further, in this embodiment, since there are provided the LED supporting members 25 supporting the LED elements 26 and heatsink plates 24 extending radially from the LED supporting members 25, and the heatsink plates 24 are arranged to extend widthwise in the plane substantially parallel to the optical axis of the concave reflecting surfaces 16, adequate heat dissipation from LED elements 26 can be realized to extend the LED elements' life, and still the presence of the heatsink plates 24 is substantially prevents from obstructing the light illumination.

Though in the aforementioned embodiment, the combination of the emitting colors of the LED elements 26 in each LED unit 10 is white, blue and red, other color combinations may be used.

Though in the aforementioned embodiments, the number of the LED units 10 is five, it may be any number.

Though in the aforementioned embodiments, the number of LED elements 26 of each LED unit 10 is three, it may be any number equal to or greater than two.

Although a preferred embodiment of the present invention has been shown and described herein, it should be apparent that the present disclosure is made by way of example only and that variations thereto are possible within the scope of the disclosure without departing from the subject matter coming within the scope of the following claims and a reasonable equivalency thereof.

What is claimed is:

1. A medical lighting apparatus comprising single or plural LED units;
each of said LED units comprising:
a plurality of concave reflecting surfaces; and
an LED element disposed in front of each of said reflecting surfaces so as to radiate light toward each of said reflecting surfaces;
each of said LED units being arranged so that the lights radiated from said LED elements are reflected by said reflecting surfaces, emerge outside and are superimposed on one another on an area to be illuminated, respectively, while illuminating said area; and
said LED elements of each of said LED units comprising a combination of different emitting colors so as to enhance the color rendering properties.

2. A medical lighting apparatus as set forth in claim 1, said combination of different emitting colors of said LED elements in each of said LED units is white, blue and red.

3. A medical lighting apparatus as set forth in claim 1, further comprising an LED supporting member supporting said LED element, and heatsink plates extending radially from said LED supporting member, said heatsink plates being arranged to extend widthwise in the plane substantially parallel to the optical axis of said concave reflecting surface.

4. A medical lighting apparatus comprising:
a main body;
a plurality of LED units supported by said main body around the axis of said main body, tiltable relative to the axis of said main body;
a focusing member mounted on said main body; and
a focus adjusting linkage mechanism, interposed between said LED units and said focusing member, for changing the angles of inclinations of said LED units relative to said axis of said main body in synchronization with each other so as to shift the focus of lights emerging outside from said LED units when said focusing member is operated;
each of said LED units comprising:
a plurality of concave reflecting surfaces; and
an LED elements disposed in front of each of said reflecting surfaces so as to radiate light toward each of said reflecting surfaces;
each of said LED units being arranged so that the lights radiated from said LED elements are reflected by said reflecting surfaces, emerge outside and are superimposed on one another on an area to be illuminated, respectively, while illuminating said area; and
said LED elements of each of said LED units comprising a combination of different emitting colors so as to enhance the color rendering properties.

5. A medical lighting apparatus as set forth in claim 4, said- combination of different emitting colors of said LED elements in each of said LED units is white, blue and red.

6. A medical lighting apparatus as set forth in claim 4, further comprising an LED supporting member supporting said LED element, and heatsink plates extending radially from said LED supporting member, said heatsink plates being arranged to extend widthwise in the plane substantially parallel to the optical axis of said concave reflecting surface.
